(19) United States
(12) Patent Application Publication
(10) Pub. No.: US 2006/0088156 A1
(43) Pub. Date: Apr. 27, 2006

(54) Cfm mode system

(75) Inventors: Yaacov Belenky, Maaleh Adumim (IL); Chaim D Shen-Orr, Haifa (IL)

Correspondence Address: WELSH & KATZ, LTD, 120 S RIVERSIDE PLAZA, 22ND FLOOR, CHICAGO, IL, 60606, US

(73) Assignee: NDS LIMITED, One London Road, Staines, Middlesex (GB)

(21) Appl. No.: 10/541,002

(22) PCT Filed: Feb. 16, 2004
(86) PCT No.: PCT/IL04/00144

§ 371 Date: Aug. 12, 2005

(30) Foreign Application Priority Data
Mar. 27, 2003 (IL) 155121
Jul. 15, 2003 (IL) 156950

(51) Int. Cl. H04L 9/28

(52) U.S. Cl. 380/28

(57) ABSTRACT

A method for producing at least one ciphertext block from at least one plaintext block using a block cipher E and a key K, the method including receiving n plaintext blocks, wherein n is an integer greater than 0, setting Q₀ equal to an initial value, and for each plaintext block of the n plaintext blocks: computing Qᵢ=E_{K}(Qᵢ₋₁) XOR Pᵢ; and computing Cᵢ=M(Pᵢ, Qᵢ), thereby producing n ciphertext blocks, wherein 0<i≦n, and Pᵢ denotes an i-th plaintext block of the n plaintext blocks, and Cᵢ denotes an i-th ciphertext block of the n ciphertext blocks, and M is a selector function which, for each bit Cᵢⱼ of block Cᵢ, selects a first argument of M if bit Pᵢⱼ is not to be encrypted, and selects a second argument of M if bit Pᵢⱼ is to be encrypted. Related apparatus and methods are also provided.

### FIELD OF THE INVENTION

The present invention relates to block cipher systems in general, and in particular to block cipher systems in CFM mode.

### BACKGROUND OF THE INVENTION

Block ciphers are well known in the art, as is the use of block ciphers in Cipher Feedback mode (CFM), also known as Cipher Feed Back (CFB) mode. CFM mode was originally defined as a mode of operation of the well known DES system; see, for example, the following references:

1. NIST, FIPS Publication 81: DES Modes of Operation, 1980, which is available on the Internet at:
csrc.nist.gov/publications/fips/fips81/fips81.htm

2. ANSI, American National Standard X3.106-1983 (R1966): Data Encryption Algorithm, Modes of Operations for the, 1983.

A short description of CFM mode may be found on the Internet at:
www.rsasecurity.com/rsalabs/faq/2-1-4-4.html

The disclosures of all references mentioned above and throughout the present specification are hereby incorporated herein by reference.

### SUMMARY OF THE INVENTION

The present invention seeks to provide an improved block cipher system, particularly but not exclusively useful for hardware-based encryption and decryption, especially for encryption and decryption of digital content.

In general, devices which encrypt and decrypt digital content must perform both encryption and decryption of data. Preferably, in order to simplify hardware design and minimize hardware gate count, the inventors of the present invention believe that the following requirements should preferably be met:

1. An encryption engine should preferably be provided in hardware for only one direction of a block cipher.

2. Data to be encrypted/decrypted (referred to herein as “data”) comprises a plurality of packets. Encryption/decryption of a packet must in no way relate to any previous packet or packets. In other words, it is prohibited to have any “chaining” from one packet to another in decryption. The typical reason for the prohibition of “chaining” is that the physical stream to be decrypted is typically multiplexed from multiple logical stream, so any “chaining” information must be stored and managed for each logical stream independently; persons skilled in the art will appreciate that such a “heavy” requirement should be avoided.

3. The encryption/decryption key is changed much less often than packets arrive; therefore, many packets are encrypted with the same key.

4. Packet encryption and decryption should be performed in one pass.

5. Certain bits of the packet must not be affected by encryption and decryption. That is, certain bits must stay “in the clear”; bits, bytes, or data that must stay in the clear are also termed herein “Must Stay Clear” or “MSC” bits, bytes or data. The reason for the requirement of certain bits being unaffected by encryption and decryption is in order to have some information about the stream available in the clear even before decryption. For example, and without limiting the generality of the foregoing, in an MPEG-2 transport stream the four first bytes of each packet stay in the clear; the four first bytes provide: information needed for demultiplexing; information as to whether the packet is encrypted at all; if the packet is encrypted, information as to whether the packet is encrypted with even or odd key; and other information as is well known in the art. In some packets, the header indicates that an initial part of the packet is the “adaptation field” which provides some other information necessary for the receiver; such information must always stay in the clear as well. Optionally a broadcaster may choose to send even part of video information in the clear, for example to make search easier in personal video recorder (PVR) systems.

Prior art encryption systems address the above-mentioned requirements only partially; in particular, requirement 1 is not addressed.

Reference is now made to FIGS. 1A and 1B, which are simplified block diagram illustrations of a prior art block cipher system operating in CFM mode. FIG. 1A illustrates encryption, while FIG. 1B illustrates decryption. Persons skilled in the art will appreciate that, without requirement 4, it is possible to use any appropriate block cipher in CFM mode:
C₀=IV
Cᵢ=E_{K}(Cᵢ₋₁)XOR Pᵢ
where 0<i≦the number of blocks being processed.
Where
Pᵢ, Cᵢ
are the i-th blocks of plaintext and ciphertext respectively, E is any appropriate block mode cipher, K is a key, and IV is an initial value, which may optionally comprise a publicly known initial value.

The corresponding decryption method is:
C₀=IV
Pᵢ=E_{K}(Cᵢ₋₁)XOR Cᵢ
where 0<i≦the number of blocks being processed.

As is well known in the art, CFM mode is intended to allow a block cipher to be used as if it were a stream cipher, so that processing may occur on a byte-by-byte basis or even on a bit-by-bit basis, rather than on a block-by-block basis.

The present invention, in preferred embodiments thereof, provides improved block cipher systems which are intended to better address the above-mentioned requirements.

There is thus provided in accordance with a preferred embodiment of the present invention a method for producing at least one ciphertext block from at least one plaintext block using a block cipher E and a key K, the method including receiving n plaintext blocks, wherein n is an integer greater than 0, setting Q₀ equal to an initial value, and for each plaintext block of the n plaintext blocks: computing Qᵢ=E_{K}(Qᵢ₋₁) XOR Pᵢ; and computing Cᵢ=M(Pᵢ,Qᵢ), thereby producing n ciphertext blocks, wherein 0<i<=n, and Pᵢ denotes an i-th plaintext block of the n plaintext blocks, and Cᵢ denotes an i-th ciphertext block of the n ciphertext blocks, and M is a selector function which, for each bit Cᵢⱼ of block Cᵢ, selects a first argument of M if bit Pᵢⱼ is not to be encrypted, and selects a second argument of M if bit Pᵢⱼ is to be encrypted.

Further in accordance with a preferred embodiment of the present invention M is chosen in accordance with a standard indicating bits that are not to be encrypted

Still further in accordance with a preferred embodiment of the present invention the standard includes one of the following an audio standard, a video standard, and an audio-video standard.

Additionally in accordance with a preferred embodiment of the present invention the standard includes MPEG-2.

There is also provided in accordance with another preferred embodiment of the present invention a method for producing at least one ciphertext block from at least one plaintext block using a block cipher E and a key K, the method including receiving n plaintext blocks, wherein n is an integer greater than 0, and an initial value IV, computing IV′=M(P₁,IV), computing Q₀=H(IV′), and for each plaintext block of the n plaintext blocks: computing Qᵢ=E_{K}(Qᵢ₋₁) XOR Pᵢ; and computing Cᵢ=M(Pᵢ,Qᵢ), thereby producing n ciphertext blocks, wherein 0<i<=n, and H is a hash function, and Pᵢ denotes an i-th plaintext block of the n plaintext blocks, and Cᵢ denotes an i-th ciphertext block of the n ciphertext blocks, and M is a selector function which, for each bit Cᵢⱼ of block Cᵢ, selects a first argument of M if bit Pᵢⱼ is not to be encrypted, and selects a second argument of M if bit Pᵢⱼ is to be encrypted.

Further in accordance with a preferred embodiment of the present invention H includes SHA1.

Still further in accordance with a preferred embodiment of the present invention H(IV′) includes E_{K}(IV′) XOR IV′.

Additionally in accordance with a preferred embodiment of the present invention M is chosen in accordance with a standard indicating bits that are not to be encrypted.

Moreover in accordance with a preferred embodiment of the present invention the standard includes one of the following an audio standard, a video standard, and an audio-video standard.

Further in accordance with a preferred embodiment of the present invention the standard includes MPEG-2.

There is also provided in accordance with another preferred embodiment of the present invention, in a method for producing at least one ciphertext block from at least one plaintext block using a block cipher E and a key K in a stream mode, wherein Pᵢ denotes an i-th plaintext block, and Cᵢ denotes an i-th ciphertext block, an improvement including for each bit Cᵢⱼ of block Cᵢ, selecting Pᵢⱼ as an output if bit Pᵢⱼ is not to be encrypted.

Further in accordance with a preferred embodiment of the present invention the stream mode includes CFM mode.

There is also provided in accordance with another preferred embodiment of the present invention apparatus for producing at least one ciphertext block from at least one plaintext block using a block cipher E and a key K, the at least one plaintext block including n plaintext blocks, the at least one ciphertext block including n ciphertext blocks, wherein n is an integer greater than 0, the apparatus including an initialization unit for setting Q₀ equal to an initial value, and a computation unit operative, for each plaintext block of the n plaintext blocks: to compute Qᵢ=E_{K}(Qᵢ₋₁) XOR Pᵢ; and to compute Cᵢ=M(Pᵢ,Qᵢ), wherein 0<i<=n, and Pᵢ denotes an i-th plaintext block of the n plaintext blocks, and Cᵢ denotes an i-th ciphertext block of the n ciphertext blocks, and M is a selector function which, for each bit Cᵢⱼ of block Cᵢ, selects a first argument of M if bit Pᵢⱼ is not to be encrypted, and selects a second argument of M if bit Pᵢⱼ is to be encrypted.

There is also provided in accordance with yet another preferred embodiment of the present invention apparatus for producing at least one ciphertext block from at least one plaintext block using a block cipher E, a key K, and an initial value IV, the at least one plaintext block including n plaintext blocks, the at least one ciphertext block including n ciphertext blocks, wherein n is an integer greater than 0, the apparatus including a first computation unit for computing IV′=M(P₁,IV), a second computation unit for computing Q₀=H(IV′), and a third computation unit operative, for each plaintext block of the n plaintext blocks: to compute Qᵢ=E_{K}(Qᵢ₋₁) XOR Pᵢ, and to compute Cᵢ=M(Pᵢ,Qᵢ), wherein ₀<i<=n, and H is a hash function, and Pᵢ denotes an i-th plaintext block of the n plaintext blocks, and Cᵢ denotes an i-th ciphertext block of the n ciphertext blocks, and M is a selector function which, for each bit Cᵢⱼ of block Cᵢ, selects a first argument of M if bit Pᵢⱼ is not to be encrypted, and selects a second argument of M if bit Pᵢⱼ is to be encrypted.

There is also provided in accordance with still another preferred embodiment of the present invention, in apparatus for producing at least one ciphertext block from at least one plaintext block using a block cipher E and a key K in a stream mode, wherein Pᵢ denotes an i-th plaintext block, and Cᵢ denotes an i-th ciphertext block, an improvement including a selector unit operative, for each bit Cᵢⱼ of block Cᵢ, to select Pᵢⱼ as an output if bit Pᵢⱼ is not to be encrypted.

There is also provided in accordance with yet another preferred embodiment of the present invention a method for producing at least one plaintext block from at least one ciphertext block encrypted using a block cipher E and a key K, the method including receiving n ciphertext blocks, where n is an integer greater than 0, setting Q₀ equal to an initial value, and for each ciphertext block of the n ciphertext blocks: computing Q′ᵢ=E_{K}(Qᵢ₋₁) XOR Cᵢ; computing Pᵢ=M(Cᵢ, Q′ᵢ); and computing Qᵢ=M(Q′ᵢ, Cᵢ), thereby producing n plaintext blocks, wherein 0<i<=n, and Pᵢ denotes an i-th plaintext block of the n plaintext blocks, and Cᵢ denotes an i-th ciphertext block of the n ciphertext blocks, and M is a selector function which, for each bit Cᵢⱼ of block Cᵢ, selects a first argument of M if bit Pᵢⱼ is not encrypted, and selects a second argument of M if bit Pᵢⱼ is encrypted.

Further in accordance with a preferred embodiment of the present invention M is chosen in accordance with a standard indicating bits that are not encrypted.

Still further in accordance with a preferred embodiment of the present invention the standard includes one of the following an audio standard, a video standard, and an audio-video standard.

Additionally in accordance with a preferred embodiment of the present invention the standard includes MPEG-2.

There is also provided in accordance with another preferred embodiment of the present invention a method for producing at least one plaintext block from at least one ciphertext block using a block cipher E and a key K, the method including receiving n ciphertext blocks, wherein n is an integer greater than 0, and an initial value IV, computing IV′=M(P₁,IV), computing Q₀=H(IV′), and for each ciphertext block of the n ciphertext blocks: computing Q′_{i=E}_{K(Q}ᵢ₋₁) XOR Cᵢ, computing Pᵢ=M(Cᵢ, Q′ᵢ), and computing Qᵢ=M(Q′ᵢ, Cᵢ), thereby producing n plaintext blocks, wherein 0<i<=n, and H is a hash function, and Pᵢ denotes an i-th plaintext block of the n plaintext blocks, and Cᵢ denotes an i-th ciphertext block of the n ciphertext blocks, and M is a selector function which, for each bit Cᵢⱼ of block Cᵢ, selects a first argument of M if bit Pᵢⱼ is not encrypted, and selects a second argument of M if bit Pᵢⱼ is encrypted.

Further in accordance with a preferred embodiment of the present invention H includes SHA1.

Still further in accordance with a preferred embodiment of the present invention H(IV′) includes E_{K}(IV′) XOR IV′.

Additionally in accordance with a preferred embodiment of the present invention M is chosen in accordance with a standard indicating bits that are not encrypted.

Moreover in accordance with a preferred embodiment of the present invention the standard includes one of the following an audio standard, a video standard, and an audio-video standard.

Further in accordance with a preferred embodiment of the present invention the standard includes MPEG-2.

There is also provided in accordance with another preferred embodiment of the present invention, in a method for producing at least one plaintext block from at least one ciphertext block using a block cipher E and a key K in a stream mode, wherein Pᵢ denotes an i-th plaintext block of the plurality of plaintext blocks, and Cᵢ denotes an i-th ciphertext block of the plurality of ciphertext blocks, an improvement including for each bit Pᵢⱼ of block Pᵢ, selecting Cᵢⱼ as an output if bit Cᵢⱼ is not encrypted.

Further in accordance with a preferred embodiment of the present invention the stream mode includes CFM mode.

There is also provided in accordance with another preferred embodiment of the present invention apparatus for producing at least one plaintext block from at least one ciphertext block encrypted using a block cipher E and a key K, the at least one ciphertext block including n ciphertext blocks, the at least one plaintext block including n plaintext blocks, wherein n is an integer greater than 0, the apparatus including initialization apparatus for setting Q₀ equal to an initial value, and a computation unit operative, for each ciphertext block of the n ciphertext blocks: to compute Q′ᵢ=E_{K}(Qᵢ₋₁) XOR Cᵢ; to compute Pᵢ=M(Cᵢ, Q′ᵢ); and to compute Qᵢ=M(Q′ᵢ, Cᵢ), wherein 0<i<=n, and Pᵢ denotes an i-th plaintext block of the n plaintext blocks, and Cᵢ denotes an i-th ciphertext block of the n ciphertext blocks, and M is a selector function which, for each bit Cᵢⱼ of block Cᵢ, selects a first argument of M if bit Pᵢⱼ is not encrypted, and selects a second argument of M if bit Pᵢⱼ is encrypted.

There is also provided in accordance with yet another preferred embodiment of the present invention apparatus for producing at least one plaintext block from at least one ciphertext block using a block cipher E and a key K, the at least one ciphertext block including n ciphertext blocks, the at least one plaintext block including n plaintext blocks, wherein n is an integer greater than 0, the apparatus including a first computation unit for computing IV′=M(P₁,IV), a second computation unit for computing Q₀=H(IV′), and a third computation unit operative, for each ciphertext block of the n ciphertext blocks: to compute Q′ᵢ=E_{K}(Qᵢ₋₁) XOR Cᵢ; to compute Pᵢ=M(Cᵢ, Q′ᵢ); and to compute Qᵢ=M(Q′ᵢ, Cᵢ), wherein 0<i<=n, and H is a hash function, and Pᵢ denotes an i-th plaintext block of the n plaintext blocks, and Cᵢ denotes an i-th ciphertext block of the n ciphertext blocks, and M is a selector function which, for each bit Cᵢⱼ of block Cᵢ, selects a first argument of M if bit Pᵢⱼ is not encrypted, and selects a second argument of M if bit Pᵢⱼ is encrypted.

There is also provided in accordance with still another preferred embodiment of the present invention, in apparatus for producing at least one plaintext block from at least one ciphertext block using a block cipher E and a key K in a stream mode, wherein Pᵢ denotes an i-th plaintext block of the plurality of plaintext blocks, and Cᵢ denotes an i-th ciphertext block of the plurality of ciphertext blocks, an improvement including a selector unit operative, for each bit Pᵢⱼ of block Pᵢ, to select Cᵢⱼ as an output if bit Cᵢⱼ is not encrypted.

### BRIEF DESCRIPTION OF THE DRAWINGS

The present invention will be understood and appreciated more fully from the following detailed description, taken in conjunction with the drawings in which:

FIGS. 1A and 1B are simplified block diagram illustrations of a prior art block cipher system operating in CFM mode;

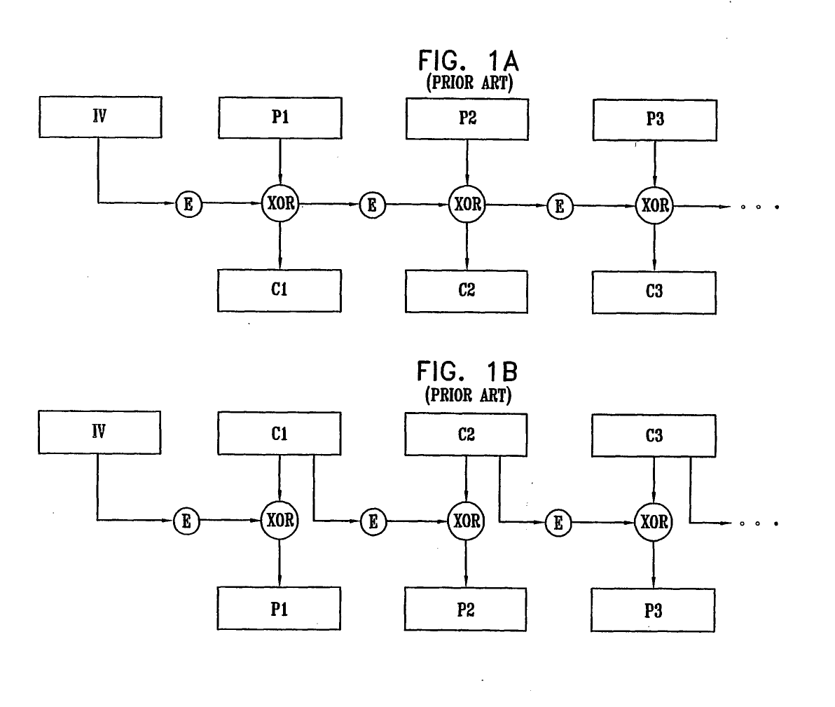

FIGS. 2A and 2B are simplified block diagram illustrations of a block cipher system constructed and operative in accordance with a first preferred embodiment of the present invention; and

FIGS. 3A and 3B are simplified block diagram illustrations of a block cipher system constructed and operative in accordance with a second preferred embodiment of the present invention.

### DETAILED DESCRIPTION OF PREFERRED EMBODIMENTS

In accordance with a first preferred embodiment of the present invention, a block cipher system based generally on CFM is provided, with a modification made to meet requirement 4 mentioned above. The modification is preferably as follows:
Q₀=IV
Qᵢ=E_{K}(Qᵢ₋₁) XOR Pᵢ
Cᵢ=M(Pᵢ,Qᵢ)
where 0<i≦the number of blocks being processed.
where for each bit
Cᵢⱼ
of block
Cᵢ
function M selects between its first argument (in this case Pᵢⱼ) and its second argument (in this case Qᵢⱼ) depending on whether the present bit of the plaintext should be encrypted or not. For a bit Cᵢⱼ, the result of function M (termed herein a “selector function”, and also known in the art as a multiplexer) may depend on all preceding blocks of the plaintext, and on those preceding bits of the plaintext in the current block Cᵢ that are not encrypted.

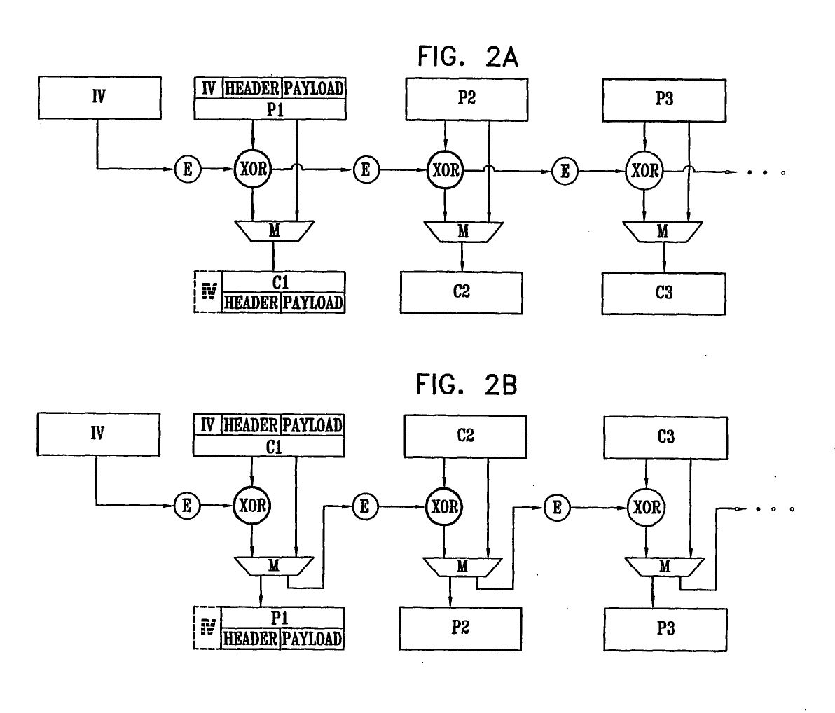

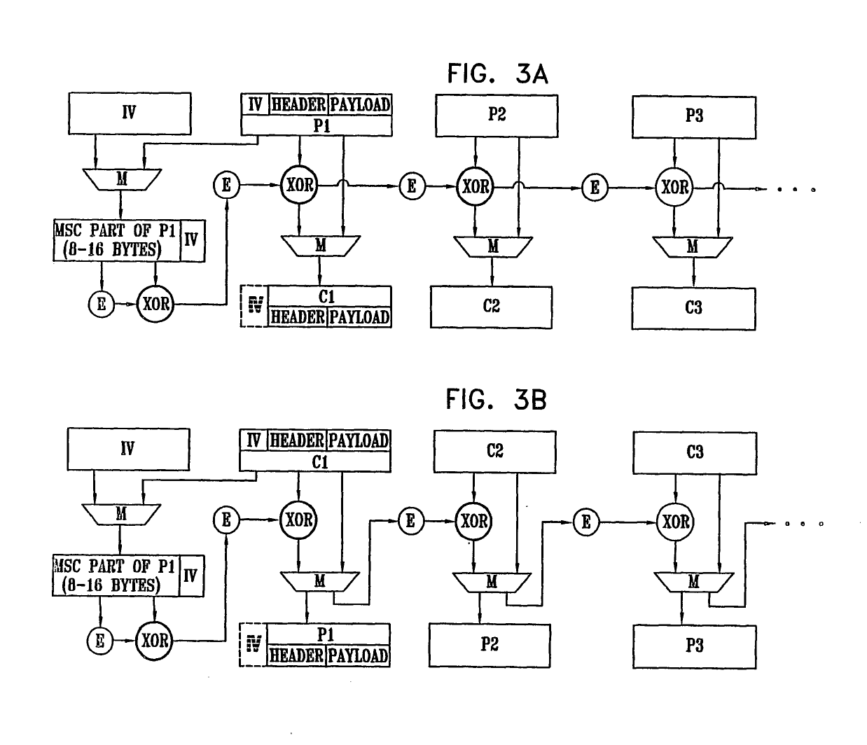

It is appreciated that the function M is chosen based on operational requirements which specify which bits should or should not be encrypted, as is explained in more detail below with reference to FIGS. 2A, 2B, 3A, and 3B.

The corresponding decryption method is:
Q₀=IV
Q′ᵢ=E_{K}(Qᵢ₋₁) XOR Cᵢ
Pᵢ=M(Cᵢ, Q′ᵢ)
Qᵢ=M(Q′ᵢ, Cᵢ)
where 0<i≦the number of blocks being processed.

Persons skilled in the art will appreciate that the first preferred embodiment has a weakness, compared with regular use of the block cipher, as follows. For all packets encrypted with the same key K the first block
P₁
will be encrypted by XOR with the same pad
E_{K}(IV)
which method is insecure. More generally, in a case where there are several packets whose first n blocks are identical and (n+1)-th blocks differ, the XOR pads of those packets will be identical up to the (n+1)-th block, and different from the (n+2)-th block on.

Nevertheless, in contexts where making it easier for an unauthorized person to decrypt a small part of the content is not critical, and there is much variability between packets, as in video- and audio-streams, the indicated weakness may be tolerable.

Without limiting the generality of the foregoing, the special case of MPEG Transport Stream, such as in MPEG-2 (as described in ISO/TEC 13818-1, Information technology—Generic coding of moving pictures and associated audio information: Systems), will now be considered. Persons skilled in the art will appreciate that MPEG-2 is provided as an example only, and is not meant to be limiting.

Reference is now made to FIGS. 2A and 2B, which are simplified block diagram illustrations of a block cipher system constructed and operative in accordance with the first preferred embodiment of the present invention. FIGS. 2A and 2B illustrate the special case of the first preferred embodiment of the present invention, used in an MPEG-2 system. FIG. 2A illustrates encryption, while FIG. 2B illustrates decryption. FIGS. 2A and 2B are self-explanatory with reference to the discussion above and below.

In MPEG-2 each transport packet comprises 188 bytes. The first 4 first bytes (bytes 0-3) comprise the packet header. The first 4 bytes are always MSC bytes that must stay in the clear; that is, the first 4 bytes must not be encrypted. As is well known in the art of MPEG-2, depending on one of the bits in those bytes, there may be an additional adaptation field immediately after the header that also must stay in the clear (MSC); in such a case, byte 4 contains the length of the adaptation field. The rest of the packet should be encrypted/decrypted.

If, for example, the well-known prior art AES (which is described in FIPS Publication 197, Nov. 26, 2001, Announcing the Advanced Encryption Standard (AES, available on the Internet at csrc.nist.gov/publications/fips/fips197/fips-197.pdf) is used as a block cipher (with 16-byte blocks), each packet may be padded with a 4-byte IV (which may optionally be publicly known) before the 4 first bytes; this 4-byte IV is in addition to the 16-byte IV
C₀

After encryption, the 4 first bytes of
C₁
will be discarded; therefore, it does not matter whether the first 4 bytes should be encrypted.

In accordance with a second preferred embodiment of the present invention, which is believed by the inventor to be stronger against attack than the first preferred embodiment of the present invention, the clear part of
P₁
is mixed into the initial value. For example and without limiting the generality of the foregoing, the following method may be used:
IV′=M(P₁,IV)
Q₀=E_{K}(IV′) XOR IV′
Qᵢ=E_{K}(Qᵢ₋₁) XOR Pᵢ
Cᵢ=M(Pᵢ,Qᵢ)
where 0<i≦the number of blocks being processed.

It is appreciated that the present invention is not limited to the use of the formula
Q₀=E_{K}(IV′) XOR IV′
Rather, any appropriate hash function of IV may be used. In general, for an appropriate hash function H:
Q₀=H(IV′)

For example, and without limiting the generality of the foregoing, the well-known SHA1 hash function may be used. The SHA1 hash function is described, for example, in the following two publications:

FIPS PUB 180-1, published 17 Apr. 1995 and entitled “Secure Hash Standard”, available on the Internet at: www.itl.nist.gov/fipspubs/fip180-1.htm; and

RFC 3174, published September 2001 and entitled “US Secure Hash Algorithm 1 (SHA1), available on the Internet at www.ietf.org/rfc/rfc3174.txt?number=3174

The corresponding decryption method is:
IV′=M(P₁,IV)
Q₀=H(IV′)
Q′ᵢ=E_{K}(Qᵢ₋₁) XOR Cᵢ
Pᵢ=M(Cᵢ, Q′ᵢ)
Qᵢ=M(Q′ᵢ, Cᵢ)
where 0<i≦the number of blocks being processed.

Persons skilled in the art will appreciate that, in the second preferred embodiment of the present invention, any two packets that have a different initial clear part of the first block will have a completely different XOR pad. Therefore, the number of packets with the same XOR pad, even for the first block only, will decrease, making it more difficult to use the weakness described above with reference to the first preferred embodiment of the present invention.

Without limiting the generality of the foregoing, the special case of MPEG-2, as described above, will now be considered in connection with the second preferred embodiment of the present invention. Persons skilled in the art will appreciate that MPEG-2 is provided as an example only, and is not meant to be limiting.

Reference is now made to FIGS. 3A and 3B, which are simplified block diagram illustrations of a block cipher system constructed and operative in accordance with the second preferred embodiment of the present invention. FIGS. 3A and 3B illustrate the special case of the first preferred embodiment of the present invention, used in an MPEG-2 system. FIG. 3A illustrates encryption, while FIG. 3B illustrates decryption. FIGS. 3A and 3B are self-explanatory with reference to the discussion above and below.

It is appreciated that, in FIGS. 3A and 3B, the particular example of an XOR function as the function F is depicted; as described above, the present invention is not limited to use of the XOR function.

The above discussion of the special case of MPEG-2 with reference to FIGS. 2A and 2B also applies to FIGS. 3A and 3B.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined only by the claims which follow:

1. A method for producing at least one ciphertext block from at least one plaintext block using a block cipher E and a key K, the method comprising:
receiving n plaintext blocks, wherein n is an integer greater than 0;
setting Q₀ equal to an initial value; and
for each plaintext block of the n plaintext blocks:
computing Qᵢ=E_{K}(Qᵢ₋₁) XOR Pᵢ; and
computing Cᵢ=M(Pᵢ, Qᵢ),
thereby producing n ciphertext blocks,
wherein:
0<i<=n, and
Pᵢ denotes an i-th plaintext block of the n plaintext blocks, and
Cᵢ denotes an i-th ciphertext block of the n ciphertext blocks, and
M is a selector function which, for each bit of block Cᵢⱼ of block Cᵢ, selects a first argument of M if bit Pᵢⱼ is not to be encrypted, and selects a second argument of M if bit Pᵢⱼ is to be encrypted.

2. The method according to claim 1 and wherein M is chosen in accordance with a standard indicating bits that are not to be encrypted.

3. The method according to claim 2 and wherein the standard comprises one of the following: an audio standard; a video standard; and an audio-video standard.

4. The method according to claim 3 and wherein the standard comprises MPEG-2.

5. A method for producing at least one ciphertext block from at least one plaintext block using a block cipher E and a key K, the method comprising:
receiving n plaintext blocks, wherein n is an integer greater than 0, and an initial value IV;
computing IV′=M(P₁,IV);
computing Q₀=H(IV′);, and
for each plaintext block of the n plaintext blocks:
computing Qᵢ=E_{K}(Qᵢ₋₁) XOR Pᵢ; and
computing Cᵢ=M(Pᵢ,Qᵢ),
thereby producing n ciphertext blocks,
wherein:
0<i<=n, and
H is a hash function, and
Pᵢ denotes an i-th plaintext block of the n plaintext blocks, and
Cᵢ denotes an i-th ciphertext block of the n ciphertext blocks, and
M is a selector function which, for each bit Cᵢⱼ of block Cᵢ, selects a first argument of M if bit Pᵢⱼ is not to be encrypted, and selects a second argument of M if bit Pᵢⱼ is to be encrypted.

6. The method according to claim 5 and wherein H comprises SHA1.

7. The method according to claim 5 and wherein H(IV′) comprises E_{K}(IV′) XOR IV′.

8. The method according to claim 5 and wherein M is chosen in accordance with a standard indicating bits that are not to be encrypted.

9. The method according to claim 8 and wherein the standard comprises one of the following: an audio standard; a video standard; and an audio-video standard.

10. The method according to claim 9 and wherein the standard comprises MPEG-2.

11. In a method for producing at least one ciphertext block from at least one plaintext block using a block cipher E and a key K in a stream mode, wherein Pᵢ denotes an i-th plaintext block, and Cᵢ denotes an i-th ciphertext block, an improvement comprising:
for each bit Cᵢⱼ of block Cᵢ, selecting Pᵢⱼ as an output if bit Pᵢⱼ is not to be encrypted.

12. The method according to claim 11 and wherein the stream mode comprises CFM mode.

13. Apparatus for producing at least one ciphertext block from at least one plaintext block using a block cipher E and a key K, the at least one plaintext block comprising n plaintext blocks, the at least one ciphertext block comprising n ciphertext blocks, wherein n is an integer greater than 0, the apparatus comprising:
an initialization unit for setting Q₀ equal to an initial value; and
a computation unit operative, for each plaintext block of the n plaintext blocks:
to compute Qᵢ=E_{K}(Qᵢ₋₁) XOR Pᵢ; and
to compute Cᵢ=M(Pᵢ,Qᵢ),
wherein:
0<i<=n, and
Pᵢ denotes an i-th plaintext block of the n plaintext blocks, and
Cᵢ denotes an i-th ciphertext block of the n ciphertext blocks, and
M is a selector function which, for each bit Cᵢⱼ of block Cᵢ, selects a first argument of M if bit Pᵢⱼ is not to be encrypted, and selects a second argument of M if bit Pᵢⱼ is to be encrypted.

14. Apparatus for producing at least one ciphertext block from at least one plaintext block using a block cipher E, a key K, and an initial value IV, the at least one plaintext block comprising n plaintext blocks, the at least one ciphertext block comprising n ciphertext blocks, wherein n is an integer greater than 0, the apparatus comprising:
a first computation unit for computing IV′=M(P₁, IV);
a second computation unit for computing Q₀=H(IV′); and
a third computation unit operative, for each plaintext block of the n plaintext blocks:
to compute Qᵢ=E_{K}(Qᵢ₋₁) XOR Pᵢ; and
to compute Cᵢ=M(Pᵢ,Qᵢ),
wherein:
0<i<=n, and
H is a hash function, and
Pᵢ denotes an i-th plaintext block of the n plaintext blocks, and
Cᵢ denotes an i-th ciphertext block of the n ciphertext blocks, and
M is a selector function which, for each bit Cᵢⱼ of block Cᵢ, selects a first argument of M if bit Pᵢⱼ is not to be encrypted, and selects a second argument of M if bit Pᵢⱼ is to be encrypted.

15. In apparatus for producing at least one ciphertext block from at least one plaintext block using a block cipher E and a key K in a stream mode, wherein Pᵢ denotes an i-th plaintext block, and Cᵢ denotes an i-th ciphertext block, an improvement comprising:
a selector unit operative, for each bit Cᵢⱼ of block Cᵢ, to select Pᵢⱼ as an output if bit Pᵢⱼ is not to be encrypted.

16. A method for producing at least one plaintext block from at least one ciphertext block encrypted using a block cipher E and a key K, the method comprising:
receiving n ciphertext blocks, where n is an integer greater than 0;
setting Q₀ equal to an initial value; and
for each ciphertext block of the n ciphertext blocks:
computing Q′ᵢE_{K}(Qᵢ₋₁) XOR Cᵢ;
computing Pᵢ=M(Cᵢ, Q′ᵢ); and
computing Qᵢ=M(Q′ᵢ, Cᵢ),
thereby producing n plaintext blocks,
wherein:
0<i<=n, and
Pᵢ denotes an i-th plaintext block of the n plaintext blocks, and
Cᵢ denotes an i-th ciphertext block of the n ciphertext blocks, and
M is a selector function which, for each bit Cᵢⱼ of block Cᵢ, selects a first argument of M if bit Pᵢⱼ is not encrypted, and selects a second argument of M if bit Pᵢⱼ is encrypted.

17. The method according to claim 16 and wherein M is chosen in accordance with a standard indicating bits that are not encrypted

18. The method according to claim 17 and wherein the standard comprises one of the following: an audio standard; a video standard; and an audio-video standard.

19. The method according to claim 18 and wherein the standard comprises MPEG-2.

20. A method for producing at least one plaintext block from at least one ciphertext block using a block cipher E and a key K, the method comprising:
receiving n ciphertext blocks, wherein n is an integer greater than 0, and an initial value IV;
computing IV′=M(P₁,IV);
computing Q₀=H(IV′); and
for each ciphertext block of the n ciphertext blocks:
computing Q′ᵢE_{K}(Qᵢ₋₁) XOR Cᵢ;
computing Pᵢ=M(Cᵢ, Q′ᵢ); and
computing Qᵢ=M(Q′ᵢ, Cᵢ),
thereby producing n plaintext blocks,
wherein:
0<i<=n, and
H is a hash function, and
Pᵢ denotes an i-th plaintext block of the n plaintext blocks, and
Cᵢ denotes an i-th ciphertext block of the n ciphertext blocks, and
M is a selector function which, for each bit Cᵢⱼ of block Cᵢ, selects a first argument of M if bit Pᵢⱼ is not encrypted, and selects a second argument of M if bit Pᵢⱼ is encrypted.

21. The method according to claim 20 and wherein H comprises SHA1.

22. The method according to claim 20 and wherein H(IV′) comprises E_{K}(IV′) XOR IV′.

23. The method according to claim 20 and wherein M is chosen in accordance with a standard indicating bits that are not encrypted.

24. The method according to claim 23 and wherein the standard comprises one of the following: an audio standard; a video standard; and an audio-video standard.

25. The method according to claim 24 and wherein the standard comprises MPEG-2.

26. In a method for producing at least one plaintext block from at least one ciphertext block using a block cipher E and a key K in a stream mode, wherein Pᵢ denotes an i-th plaintext block of the plurality of plaintext blocks, and Cᵢ denotes an i-th ciphertext block of the plurality of ciphertext blocks, an improvement comprising:
for each bit Pᵢⱼ of block Pᵢ, selecting Cᵢⱼ as an output if bit Cᵢⱼ is not encrypted.

27. The method according to claim 26 and wherein the stream mode comprises CFM mode.

28. Apparatus for producing at least one plaintext block from at least one ciphertext block encrypted using a block cipher E and a key K, the at least one ciphertext block comprising n ciphertext blocks, the at least one plaintext block comprising n plaintext blocks, wherein n is an integer greater than 0, the apparatus comprising:
initialization apparatus for setting Q₀ equal to an initial value; and
a computation unit operative, for each ciphertext block of the n ciphertext blocks:
to compute Q′ᵢ=E_{K}(Qᵢ₋₁) XOR Cᵢ;
to compute Pᵢ=M(Cᵢ, Q′ᵢ); and
to compute Qᵢ=M(Q′ᵢ, Cᵢ),
wherein:
0<i<=n, and
Pᵢ denotes an i-th plaintext block of the n plaintext blocks, and
Cᵢ denotes an i-th ciphertext block of the n ciphertext blocks, and
M is a selector function which, for each bit Cᵢⱼ of block Cᵢ, selects a first argument of M if bit Pᵢⱼ is not encrypted, and selects a second argument of M if bit Pᵢⱼ is encrypted.

29. Apparatus for producing at least one plaintext block from at least one ciphertext block using a block cipher E and a key K, the at least one ciphertext block comprising n ciphertext blocks, the at least one plaintext block comprising n plaintext blocks, wherein n is an integer greater than 0, the apparatus comprising:
a first computation unit for computing IV′=M(P₁, IV);
a second computation unit for computing Q₀=H(IV′); and
a third computation unit operative, for each ciphertext block of the n ciphertext blocks:
to compute Q′ᵢ=E_{K}(Qᵢ₋₁) XOR Cᵢ;
to compute Pᵢ=M(Cᵢ, Q′ᵢ); and
to compute Qᵢ=M(Q′ᵢ, Cᵢ),
wherein:
0<i<=n, and
H is a hash function, and
Pᵢ denotes an i-th plaintext block of the n plaintext blocks, and
Cᵢ denotes an i-th ciphertext block of the n ciphertext blocks, and
M is a selector function which, for each bit Cᵢⱼ of block Cᵢ, selects a first argument of M if bit Pᵢⱼ is not encrypted, and selects a second argument of M if bit Pᵢⱼ is encrypted.

30. In apparatus for producing at least one plaintext block from at least one ciphertext block using a block cipher E and a key K in a stream mode, wherein Pᵢ denotes an i-th plaintext block of the plurality of plaintext blocks, and Cᵢ denotes an i-th ciphertext block of the plurality of ciphertext blocks, an improvement comprising:
a selector unit operative, for each bit Pᵢⱼ of block Pᵢ, to select Cᵢⱼ as an output if bit Cᵢⱼ is not encrypted.

31. A system for scrambling/descrambling packets, comprising a scrambling/descrambling device to scramble/descramble the packets based on an Initial Value and a Key, each of the packets having a must stay clear (MSC) section which must always stay in the clear, the Initial Value for each of the packets being a function of at least part of the MSC section of an associated one of the packets being processed.

32. The system according to claim 31, wherein the MSC section includes an adaptation field, the Initial Value being a function of at least part of the adaptation field of the one packet being processed.

33. The system according to claim 32, wherein the Initial Value is a function of the data content of the adaptation field of the one packet being processed.

34. A method for scrambling/descrambling packets, each of the packets having a must stay clear (MSC) section which must always stay in the clear, the method comprising:
determining an Initial Value for each of the packets as a function of at least part of the MSC section of an associated one of the packets being processed; and
scrambling/descrambling the packets based on the Initial Value and a Key.

35. The method according to claim 34, wherein the MSC section includes an adaptation field, the determining including determining the Initial Value as a function of at least part of the adaptation field of the one packet being processed.

36. The method according to claim 35, wherein the determining includes determining the Initial Value as a function of the data content of the adaptation field of the one packet being processed.

37. Apparatus for producing at least one ciphertext block from at least one plaintext block using a block cipher E and a key K, the at least one plaintext block comprising n plaintext blocks, the at least one ciphertext block comprising n ciphertext blocks, wherein n is an integer greater than 0, the apparatus comprising:
means for setting Q₀ equal to an initial value; and
means for computing:
Qᵢ=E_{K}(Qᵢ₋₁) XOR Pᵢ; and
Cᵢ=M(Pᵢ,Qᵢ),
for each plaintext block of the n plaintext blocks,
wherein:
0<i<=n, and
Pᵢ denotes an i-th plaintext block of the n plaintext blocks, and
Cᵢ denotes an i-th ciphertext block of the n ciphertext blocks, and
M is a selector function which, for each bit Cᵢⱼ of block Cᵢ, selects a first argument of M if bit Pᵢⱼ is not to be encrypted, and selects a second argument of M if bit Pᵢⱼ is to be encrypted.

38. Apparatus for producing at least one ciphertext block from at least one plaintext block using a block cipher E, a key K, and an initial value IV, the at least one plaintext block comprising n plaintext blocks, the at least one ciphertext block comprising n ciphertext blocks, wherein n is an integer greater than 0, the apparatus comprising:
means for computing IV′=M(P₁,IV);
means for computing Q₀=H(IV′); and
means for computing:
QᵢE_{K}(Qᵢ₋₁) XOR Pᵢ; and
Cᵢ=M(Pᵢ,Qᵢ),
for each plaintext block of the n plaintext blocks,
wherein:
0<i<=n, and
H is a hash function, and
Pᵢ denotes an i-th plaintext block of the n plaintext blocks, and
Cᵢ denotes an i-th ciphertext block of the n ciphertext blocks, and
M is a selector function which, for each bit Cᵢⱼ of block Cᵢ, selects a first argument of M if bit Pᵢⱼ is not to be encrypted, and selects a second argument of M if bit Pᵢⱼ is to be encrypted.

39. Apparatus for producing at least one plaintext block from at least one ciphertext block encrypted using a block cipher E and a key K, the at least one ciphertext block comprising n ciphertext blocks, the at least one plaintext block comprising n plaintext blocks, wherein n is an integer greater than 0, the apparatus comprising:
means for setting Q₀ equal to an initial value; and
means for computing:
Q′ᵢ=E_{K}(Qᵢ₋₁) XOR Cᵢ;
Pᵢ=M(Cᵢ, Q′ᵢ); and
Qᵢ=M(Q′ᵢ, Cᵢ),
for each ciphertext block of the n ciphertext blocks,
wherein:
0<i<=n, and
Pᵢ denotes an i-th plaintext block of the n plaintext blocks, and
Cᵢ denotes an i-th ciphertext block of the n ciphertext blocks, and
M is a selector function which, for each bit Cᵢⱼ of block Cᵢ, selects a first argument of M if bit Pᵢⱼ is not encrypted, and selects a second argument of M if bit Pᵢⱼ is encrypted.

40. Apparatus for producing at least one plaintext block from at least one ciphertext block using a block cipher E and a key K, the at least one ciphertext block comprising n ciphertext blocks, the at least one plaintext block comprising n plaintext blocks, wherein n is an integer greater than 0, the apparatus comprising:
means for computing IV′=M(P₁,IV);
means for computing Q₀=H(IV′); and
means for computing:
Q′ᵢ=E_{K}(Qᵢ₋₁) XOR Cᵢ;
Pᵢ=M(Cᵢ, Q′ᵢ); and
Qᵢ=M(Q′ᵢ, Cᵢ),
for each ciphertext block of the n ciphertext blocks,
wherein:
0<i<=n, and
H is a hash function, and
Pᵢ denotes an i-th plaintext block of the n plaintext blocks, and
Cᵢ denotes an i-th ciphertext block of the n ciphertext blocks, and
M is a selector function which, for each bit Cᵢⱼ of block Cᵢ, selects a first argument of M if bit Pᵢⱼ is not encrypted, and selects a second argument of M if bit Pᵢⱼ is encrypted.
